(19) United States
(12) Patent Application Publication
(10) Pub. No.: US 2019/0178995 A1
(43) Pub. Date: Jun. 13, 2019

(54) RANGING DEVICE AND METHOD THEREOF

(71) Applicant: INDUSTRIAL TECHNOLOGY RESEARCH INSTITUTE, Hsinchu (TW)

(72) Inventors: Chia-Ming TSAI, Hsinchu City (TW); Chih-Wei LAI, New Taipei City (TW); Jau-Yang WU, Changhua County (TW)

(21) Appl. No.: 15/904,981

(22) Filed: Feb. 26, 2018

(30) Foreign Application Priority Data
Dec. 8, 2017 (TW) 106143269

(51) Int. Cl. G01S 7/486; G01S 17/10

(52) U.S. Cl. CPC G01S 7/4865; G01S 17/10

(57) ABSTRACT

The ranging device includes a clock generator, a light emitter, a light sensor, and a ranging control circuit. The clock generator outputs a reference clock signal. The light emitter generates an emitted light signal modulated by the reference clock signal and emits the emitted light signal to an object. The light sensor receives a reflected light signal reflected from the object to generate a light sensing signal. The ranging control circuit includes a variable delay line. The ranging control circuit receives the reference clock signal and the light sensing signal, and generates a ranging signal accordingly to track an energy characteristic point of the light sensing signal.

This application claims the benefit of Taiwan application Serial No. 106143269, filed Dec. 8, 2017, the subject matter of which is incorporated herein by references.

### TECHNICAL FIELD

The disclosure relates to a ranging device and a ranging method applied thereto.

### BACKGROUND

Distance sensing technology has a wide range of applications in modern technology, such as proximity sensors for mobile phones, depth perception photography, detection equipment for automated machinery, and the like. One optical distance sensing technique measures the time-of-flight (TOF). In this technique the distance is obtained by calculating the round-trip time of light. However, the accuracy of distance sensing may degrade due to the non-ideal effects of hardware components and process variations. Therefore, how to improve the accuracy of the optical distance sensing device is one of the major issues in the industry.

### SUMMARY

The disclosure relates to a ranging device and a ranging method applied thereto, which improve the accuracy of distance sensing.

According to one embodiment, a ranging device is provided. The ranging device includes a clock generator, a light emitter, a light sensor, and a ranging control circuit. The clock generator is configured to output a reference clock signal. The light emitter is configured to generate an emitted light signal modulated by the reference clock signal and emit the emitted light signal to an object. The light sensor includes a single photon avalanche diode. The light sensor is configured to receive a reflected light signal reflected from the object to generate a light sensing signal. The ranging control circuit includes a variable delay line. The ranging control circuit is configured to receive the reference clock signal and the light sensing signal, and generate a ranging signal accordingly to track an energy characteristic point of the light sensing signal.

According to another embodiment, a ranging method is provided. The ranging method includes the following steps. Provide a reference clock signal. Generate an emitted light signal modulated by the reference clock signal and emit the emitted light signal to an object. Receive a reflected light signal reflected from the object by a light sensor to generate a light sensing signal, wherein the light sensor includes a single photon avalanche diode. Receive the reference clock signal and the light sensing signal by a ranging control circuit, and generate a ranging signal accordingly to track an energy characteristic point of the light sensing signal, wherein the ranging control circuit includes a variable delay line.

### BRIEF DESCRIPTION OF THE DRAWINGS

FIG. 1A shows a diagram of light sensor including a single photon avalanche diode.

FIG. 1B shows a waveform of the output voltage according to the circuit shown in FIG. 1A.

FIG. 2 shows a diagram illustrating a ranging device according to an embodiment of this disclosure.

FIG. 3 shows a flowchart illustrating a ranging method according to an embodiment of this disclosure.

FIG. 4 shows a diagram illustrating the calculation of time-of-flight according to an embodiment of this disclosure.

FIG. 5 shows a diagram illustrating a light sensor and a ranging control circuit according to an embodiment of this disclosure.

FIG. 6 shows a signal waveform of the circuit shown in FIG. 5 with the duty cycle of the delayed clock signal equal to 50%.

FIG. 7 shows a signal waveform of the circuit shown in FIG. 5 with the duty cycle of the delayed clock signal not equal to 50%.

FIG. 8 shows a diagram illustrating a ranging control circuit according to an embodiment of this disclosure.

FIG. 9 shows a diagram illustrating a time-to-digital converter for generating the ranging signal according to an embodiment of this disclosure.

FIG. 10 shows a diagram illustrating an analog-to-digital converter for generating the ranging signal according to an embodiment of this disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

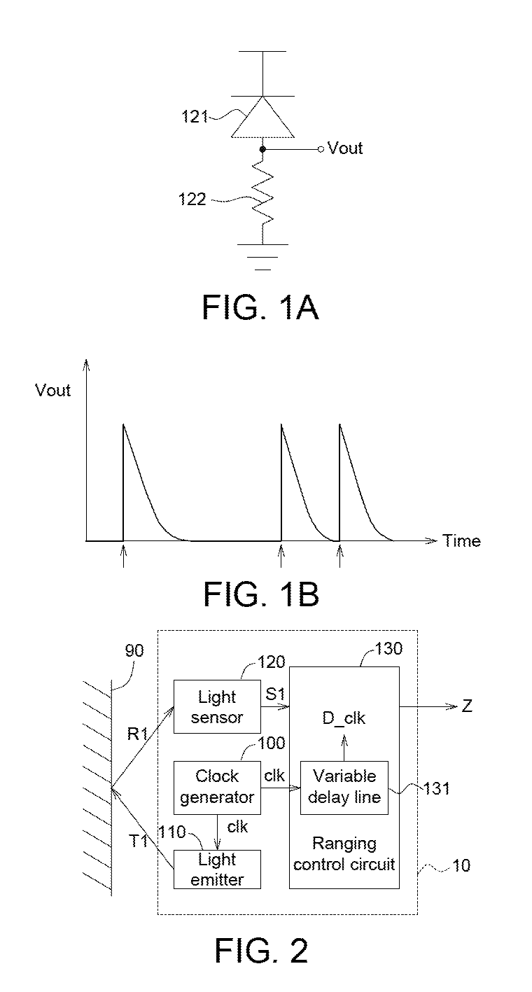

Because the single photon avalanche diode (SPAD) has large current gain and high sensitivity to light, it can be used in high-accuracy distance sensing devices. The SPAD is often used in conjunction with a quenching circuit. FIG. 1A shows a diagram of light sensor including a single photon avalanche diode. When a photon is received at the cathode of the SPAD 121, the SPAD 121 operates in Geiger mode, during which the reverse bias of the SPAD 121 exceeds its breakdown voltage, and thus a current is generated such that the output voltage Vout at the anode of the SPAD 121 rises. Please refer to FIG. 1B, which shows a waveform of the output voltage according to the circuit shown in FIG. 1A. The positions shown by the arrows in FIG. 1B indicate the events when a photon is received. The output voltage Vout rises rapidly at these events. In the example shown in FIG. 1A, the resistor 122 is used as a passive quenching circuit. The SPAD 121 is turned off when the voltage Vout rises, such that the output voltage Vout gradually returns to its original voltage level.

One distance sensing method includes emitting pulsed light to the object under test. The circuit shown in FIG. 1A is used as a light sensor. The round-trip time of light is calculated according to the signal waveform of the output voltage Vout shown in FIG. 1B. The distance of the object under test can be calculated according to the time-of-flight and the speed of light. However, calculation error may result from non-ideal effects of the pulsed light. For example, a pulse waveform generated by a non-ideal element may have a non-zero rise time, a non-zero fall time, and non-ideal waveform flatness. In addition, process variations and light emitters made by different component manufacturers may result in different optical properties, combined with the influence of ambient light, which may result in a loss of accuracy in the distance sensing system.

FIG. 2 shows a diagram illustrating a ranging device according to an embodiment of this disclosure. The ranging device 10 includes a clock generator 100, a light emitter 110, a light sensor 120, and a ranging control circuit 130. The clock generator 100 is configured to output a reference clock signal clk. The frequency of the reference clock signal clk may be in the order of MHz. The light emitter 110 is configured to generate an emitted light signal T1 modulated by the reference clock signal clk and emit the emitted light signal T1 to an object under test 90. For example, the light emitter 110 may include a light emitting diode (LED) or a laser diode. The emitted light signal T1 is for example a visible light or an infrared light. The emitted light signal T1 has a modulation frequency equal to the frequency of the reference clock signal clk.

The light sensor 120 includes a single photon avalanche diode (SPAD). The light sensor 120 is configured to receive a reflected light signal R1 reflected from the object under test 90 to generate a light sensing signal S1. The waveform of the light sensing signal S1 is for example as shown in FIG. 1B. The ranging control circuit 130 includes a variable delay line 131. The ranging control circuit 130 is configured to receive the reference clock signal clk and the light sensing signal S1, and generate a ranging signal Z accordingly to track an energy characteristic point of the light sensing signal S1. In one embodiment, the variable delay line 131 delays the reference clock signal clk to generate a delayed clock signal D_clk. The delayed clock signal D_clk tracks the energy characteristic point of the light sensing signal S1, such that a ratio of a first energy to a second energy is a fixed ratio, wherein the first energy is the energy that the light sensing signal S1 has during an enabled period of the delayed clock signal D_clk, and the second energy is the energy that the light sensing signal S1 has during a disabled period of the delayed clock signal D_clk.

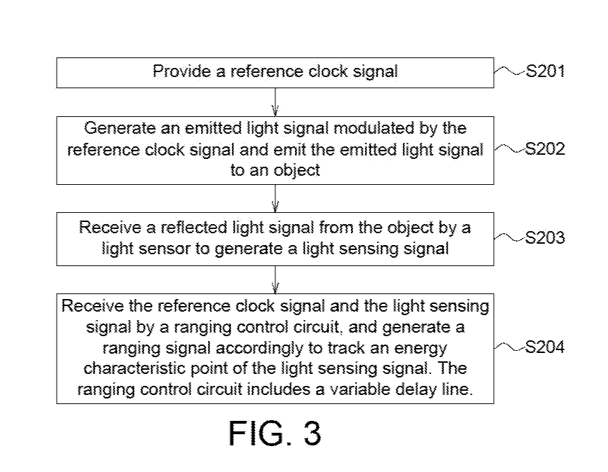

The ranging method corresponding to the ranging device 10 shown in FIG. 2 may be referred in FIG. 3, which shows a flowchart illustrating a ranging method according to an embodiment of this disclosure. The ranging method includes the following steps. Step S201: Provide a reference clock signal clk. The step S201 may be performed by the clock generator 100. Step S202: Generate an emitted light signal T1 modulated by the reference clock signal clk and emit the emitted light signal T1 to an object under test 90. The step S202 may be performed by the light emitter 110. Step S203: Receive a reflected light signal R1 reflected from the object under test 90 by a light sensor 120 to generate a light sensing signal S1. Step S204: Receive the reference clock signal clk and the light sensing signal S1 by a ranging control circuit 130, and generate a ranging signal Z accordingly to track an energy characteristic point of the light sensing signal S1, wherein the ranging control circuit 130 includes a variable delay line 131. In one embodiment, the variable delay line 131 delays the reference clock signal clk to generate a delayed clock signal D_clk. The delayed clock signal D_clk tracks the energy characteristic point of the light sensing signal S1.

In the step S204, the variable delay line 131 adjusts a delay amount of the delayed clock signal D_clk relative to the reference clock signal clk to make the operation of the ranging control circuit 130 reach a steady state. The steady state represents that the delayed clock signal D_clk has successfully tracked the energy characteristic point of the light sensing signal S1. The energy characteristic point may divide the energy of the light sensing signal S1 into two parts: the first energy during the enabled period of the delayed clock signal D_clk and the second energy during the disabled period of the delayed clock signal D_clk. The ratio of the first energy to the second energy remains a fixed ratio when reaching the steady state.

When the delayed clock signal D_clk successfully tracks the energy characteristic point of the light sensing signal S1, the time-of-flight (TOF) of the light may be calculated according to the delay amount of the delayed clock signal D_clk relative to the reference clock signal clk, so as to determine the distance of the object under test 90. In one embodiment, the delayed clock signal D_clk has successfully tracked the energy characteristic point of the light sensing signal S1 when the first energy is approximately equal to the second energy. In this embodiment the fixed ratio between the first energy and the second energy is 1:1, and the energy characteristic point may also be referred to as the energy center point of the light sensing signal S1. In other embodiments, the fixed ratio between the first energy and the second energy may be 2:3, 3:4, 55:45, or other ratios. The fixed ratio may be related to the component characteristics of the circuit hardware. The ranging device proposed in this disclosure does not limit the numerical value of this fixed ratio. The time-of-flight of the light may be calculated once the ratio of the first energy to the second energy remains fixed.

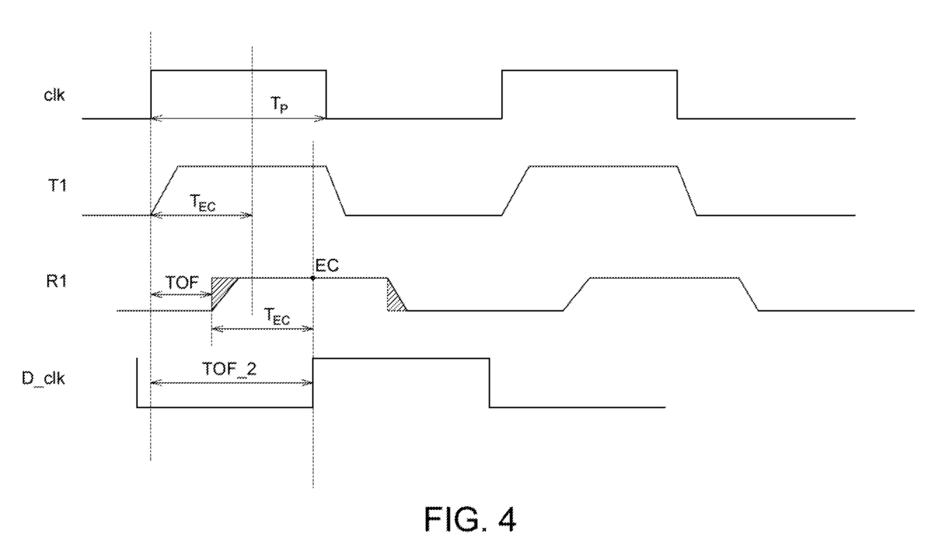

FIG. 4 shows a diagram illustrating the calculation of time-of-flight according to an embodiment of this disclosure. The reference clock signal has a period T_{P}. The emitted light signal T1 has a modulation frequency approximately equal to the frequency of the reference clock signal clk. The emitted light signal T1 has non-zero rise time and non-zero fall time due to the non-ideal effects from hardware components. The time difference between the reflected light signal R1 and the emitted light signal T1 is the time-of-flight TOF. The reflected light signal R1 is received by the light sensor 120 for generating the light sensing signal S1. The energy characteristic point of the reflected light signal R1 is close to the energy characteristic point of the light sensing signal S1. As shown in FIG. 4, the rising edge of the delayed clock signal D_clk is approximately at the energy characteristic point EC of the reflected light signal R1 when the delayed clock signal D_clk has tracked the characteristic point of the light sensing signal S1. Taking the energy center point for example, the rising edge of the delayed clock signal D_clk is located approximately at the center point of the positive half cycle of the reflected light signal R1.

The delay amount of the delayed clock signal D_clk relative to the reference clock signal is TOF_2 when reaching the steady state. The time length T_{EC} between the beginning of the positive half cycle and the energy characteristic point EC of the reflected light signal R1 (the energy center point is taken as an example for the energy characteristic point EC) is approximately equal to the time length T_{EC} between the beginning of the positive half cycle and the energy characteristic point of the emitted light signal T1. As shown in FIG. 4, the relationship between each time length may be represented as:

TOF_2=TOF+T_{EC} formula (1).

T_{EC} is a constant, which is related to the pulse width of the reference clock signal clk and the fixed ratio between the first energy and the second energy. For example, the fixed ratio of the first energy to the second energy is 1:1 when tracking the energy center point, and the time length T_{EC} is approximately 0.5 times of the period T_{P}; when the fixed ratio of the first energy to the second energy is 2:3, the time length T_{EC} is approximately 0.6 times of the period T_{P}. The time length T_{EC} is independent of the light signal received by the light sensor 120, and is a constant value that can be obtained before performing distance sensing. Regarding the time length T_{EC}, this constant value may be provided in a calibration process before the device is shipped from the factory. Alternatively, a reference point on the mechanism may be used for determining the time length T_{EC}. In practice, the exact position of the signal waveform corresponding to the time length T_{EC} is not limited as long as the time length T_{EC} can be obtained in advance. For example, the time length T_{EC} may be regarded as a constant value obtained by the ranging device 10 in advance under the circumstance that the time-of-flight TOF equals zero. When the ranging device 10 actually senses the distance to the object under test 90, the time length TOF_2 may be obtained after the delayed clock signal D_clk successfully tracks the energy characteristic point EC. According to the formula (1), the time-of-flight TOF may be calculated by subtracting the time length T_{EC} that is known in advance from the time length TOF_2.

According to the signal waveform shown in FIG. 4, the ranging device 10 in one embodiment of this disclosure shown in FIG. 2 uses the delay time length TOF_2 to calculate the time-of-flight TOF. When the ranging device 10 determines the delay time length TOF_2, the positions where the light signal has more severe non-ideal effects can be avoided. Such positions include for example the rise time and the fall time (the shaded area of the reflected light signal R1 in FIG. 4). The rising edge of the delayed clock signal D_clk is located at a region that is relatively flat in the waveform of the reflected light signal R1. Therefore, the non-ideal effect from the modulated light signal can be avoided, and a more accurate distance sensing result can be obtained. For example, in general the rise time and the fall time occupy less than a half cycle of a laser light signal. When the rising edge of the delayed clock signal D_clk is close to the energy center point of the reflected light signal R1, the rising edge of the delayed clock signal D_clk can be located at a flat region where the energy level of the reflected light signal R1 is relatively constant, avoiding the rising edge or the falling edge of the reflected light signal R1 where the energy changes drastically.

In addition, because the ranging device 10 tracks the energy characteristic point, the accuracy is affected only by the relative relation between the first energy and the second energy. The first energy may be regarded as being related to the time length that the positive half cycle of the reflected light signal R1 (or the light sensing signal S1) overlaps with the positive half cycle (i.e. the enabled period) of the delayed clock signal D_clk. The second energy may be regarded as being related to the time length that the positive half cycle of the reflected light signal R1 (or the light sensing signal S1) overlaps with the negative half cycle (i.e. the disabled period) of the delayed clock signal D_clk. As such, even if there is a background ambient light which increases the energy level of the reflected light signal R1, the determination regarding the relative relation between the first energy and the second energy will not be affected, and thus the position of the tracked energy characteristic point will not be affected. The ranging device 10 in this disclosure is highly resistant to the ambient light interference.

In another embodiment, the ranging control circuit 130 may include a charge pump circuit and a capacitor. The function of tracking the energy characteristic point may be implemented by charging and discharging the capacitor. When the charging and discharging of the capacitor reach a balanced steady state, it represents that the energy characteristic point has been tracked successfully. For example, the energy charged by the charge pump circuit to the capacitor is approximately equal to the energy discharged by the charge pump circuit for the capacitor when the delayed clock signal D_clk has successfully tracked the energy characteristic point of the light sensing signal S1.

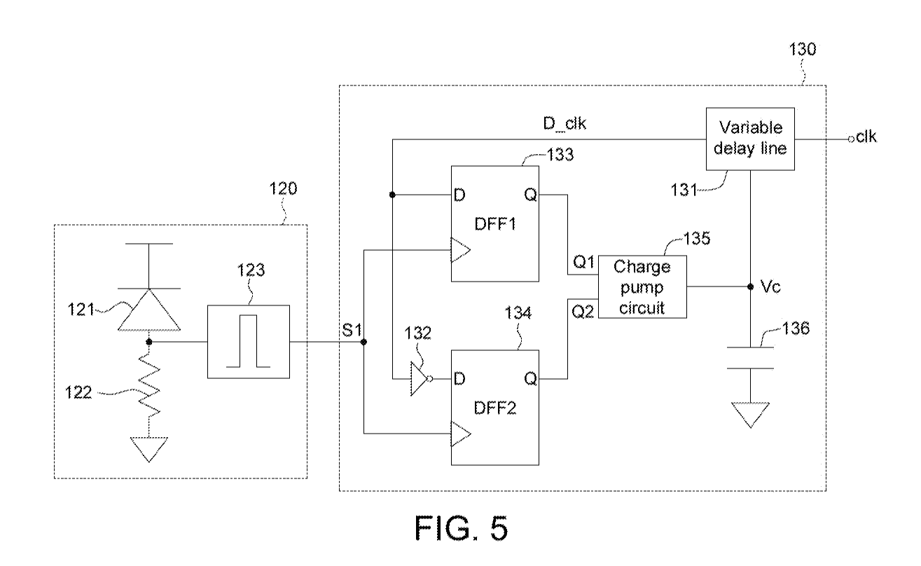

FIG. 5 shows a diagram illustrating a light sensor and a ranging control circuit according to an embodiment of this disclosure. In this embodiment, the light sensor 120 includes a SPAD 1221, a resistor 122, and a pulse shaping circuit 123. The resistor 122 may be replaced by other passive or active quenching circuit that can be used in conjunction with the SPAD 121. The pulse shaping circuit 123 is an optional circuit block. The pulse shaping circuit 123 is coupled to the SPAD 121 for outputting the light sensing signal S1. The pulse shaping circuit 123 is configured to transform the signal waveform shown in FIG. 1B into a sharper and cleaner pulse waveform, such as increasing the voltage drop rate of the signal in FIG. 1B. As such, the light sensing signal S1 generated by the pulse shaping circuit 123 includes a pulse train. The pulse shaping circuit 123 helps in enhancing the circuit reliability.

The ranging control circuit 130 includes a variable delay line 131, an inverter 132, a first D flip-flop 133, a second D flip-flop 134, a charge pump circuit 135, and a capacitor 136. The inverter 132 receives the delayed clock signal D_clk to generate an inverted delayed clock signal. The inverter 132 is for example a logic NOT gate. The first D flip-flop 133 has a D input terminal for receiving the delayed clock signal D_clk, a clock input terminal for receiving the light sensing signal S1, and a Q output terminal for outputting a first charge/discharge control signal Q1. The second D flip-flop 134 has a D input terminal for receiving the inverted delayed clock signal, a clock input terminal for receiving the light sensing signal S1, and a Q output terminal for outputting a second charge/discharge control signal Q2. The variable delay line 131 is for example a voltage controlled delay line. The variable delay line 131 generates the delayed clock signal D_clk according to the voltage V_{C} of the capacitor 136.

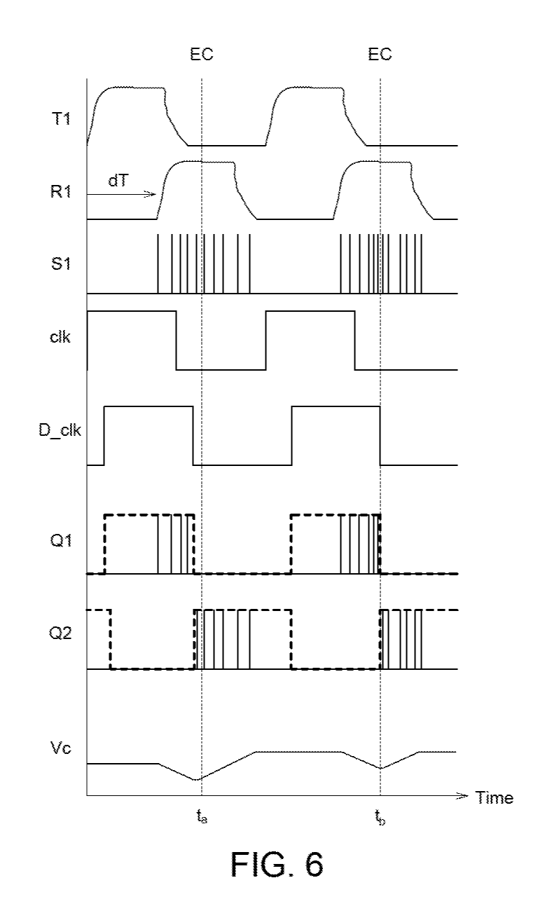

FIG. 6 shows a signal waveform of the circuit shown in FIG. 5 with the duty cycle of the delayed clock signal equal to 50%. In this example the delayed clock signal D_clk output from the variable delay line 131 has a duty cycle equal to 50%. The reflected light signal R1 is received by the light sensor 120 which generates the light sensing signal S1. The light sensing signal S1 is in pulse train form. Note that FIG. 6 is a simplified representation. In general, the light sensing signal S1 received is relatively weak, and during one operation period, one or less than one light pulse signal is detected. The position of the pulse signal appears random in the positive half cycle of the reflected light signal R1. Therefore, after several operation periods, the receiving terminal (i.e. the ranging control circuit 130) obtains the multiple pulse pattern of the light sensing signal S1 by statistics, as shown in FIG. 6. Both the first D flip-flop 133 and the second D flip-flop 134 use the light sensing signal S1 as the trigger clock, and therefore the waveforms of the first charge/discharge control signal Q1 and the second charge/discharge control signal Q2 at the respective Q output terminal are illustrated as shown in FIG. 6. For ease of viewing, the dotted line portion in the waveform of the first charge/discharge control signal Q1 represents the waveform of the delayed clock signal D_clk, and the dotted line portion in the waveform of the second charge/discharge control signal Q2 represents the waveform of the inverted delayed clock signal.

For example, the first charge/discharge control signal Q1 controls the charge pump circuit 135 to discharge the capacitor 136, and the second charge/discharge control signal Q2 controls the charge pump circuit 135 to charge the capacitor 136. At time tₐ, the system has not reached the steady state yet, the energy charged to the capacitor 136 is greater than the energy discharged from the capacitor 136, and therefore the voltage V_{C} of the capacitor 136 rises. The increased voltage V_{C} of the capacitor 136 makes the variable delay line 131 increases the delay amount. As such, at time t_{b}, the energy charged to the capacitor 136 is equal to the energy discharged from the capacitor 136, the voltage V_{C} of the capacitor 136 becomes stable, meaning that the energy characteristic point EC of the light sensing signal S1 has been successfully tracked (in this example the energy characteristic point EC is the energy center point). As shown in FIG. 6, the charging and discharging of the capacitor 136 can reach balance by controlling the delay amount of the variable delay line 131 according to the circuit feedback architecture shown in FIG. 5.

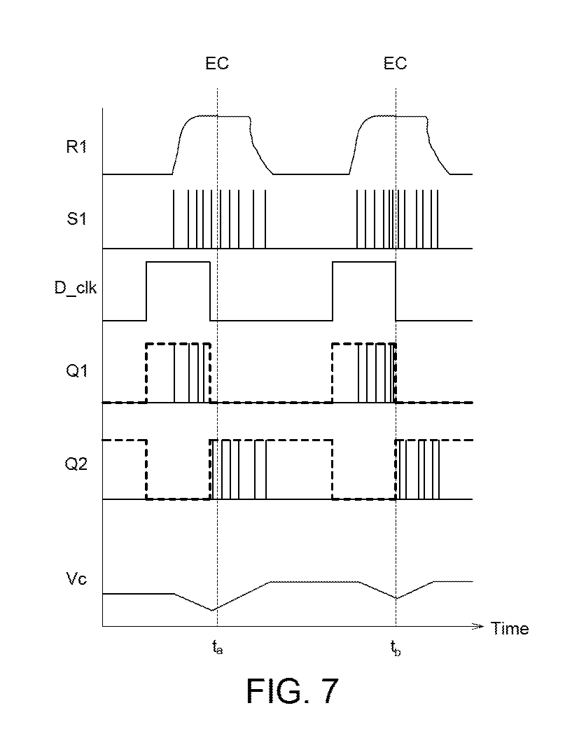

There may be non-ideal effect in the circuit hardware, and thus it is possible that the duty cycle of the delayed clock signal D_clk output from the variable delay line is not equal to 50%. Please refer to FIG. 7, which shows a signal waveform of the circuit shown in FIG. 5 with the duty cycle of the delayed clock signal not equal to 50%. Similar to the waveform shown in FIG. 6, at time tₐ, the system has not reached the steady state yet, the energy charged to the capacitor 136 is greater than the energy discharged from the capacitor 136, and therefore the voltage V_{C} of the capacitor 136 rises. The increased voltage V_{C} of the capacitor 136 makes the variable delay line 131 increases the delay amount. As such, at time t_{b}, the energy charged to the capacitor 136 is equal to the energy discharged from the capacitor 136, meaning that the energy characteristic point EC of the light sensing signal S1 has been successfully tracked (in this example the energy characteristic point EC is the energy center point). It can be seen that in this example the energy characteristic point EC can still be tracked successfully even if the duty cycle of the delayed clock signal D_clk is not equal to 50%. Therefore, the ranging device 10 in this disclosure has a good tolerable range for duty cycle variation, and there is no need for an additional calibration or compensation method.

Note that there may be hardware mismatch effect in the charge pump circuit 135, such that the charging rate differs from the discharging rate of the capacitor 136. The steady state (the charging and discharging of the capacitor 136 reach balance) can still be achieved under such circumstance (hardware mismatch) according to the circuit structure shown in FIG. 5. Because the charge pump circuit 135 has different charging rate/discharging rate, the number of pulses that the light sensing signal S1 has during the enabled period of the delayed clock signal D_clk (this number is related to the first energy) is different from the number of pulses that the light sensing signal S1 has during the disabled period of the delayed clock signal D_clk (this number is related to the second energy) in the steady state. In this situation, what is tracked is no longer the energy center point, but an energy characteristic point where the ratio of the first energy to the second energy is a fixed ratio.

In the situation described above where the charging rate is different from the discharging rate, the time-of-flight of light can still be calculated because the energy characteristic point can still be tracked successfully. For example, the ranging control circuit 130 may be tested before being connected to the light sensor 120 to obtain the fixed ratio between the first energy and the second energy in the steady state. Based on this fixed ratio, the time length T_{EC} shown in FIG. 4 can be calculated. Therefore, the ranging device 10 in this disclosure is also resistant to mismatch in the circuit hardware, and there is no need for an additional calibration or compensation method.

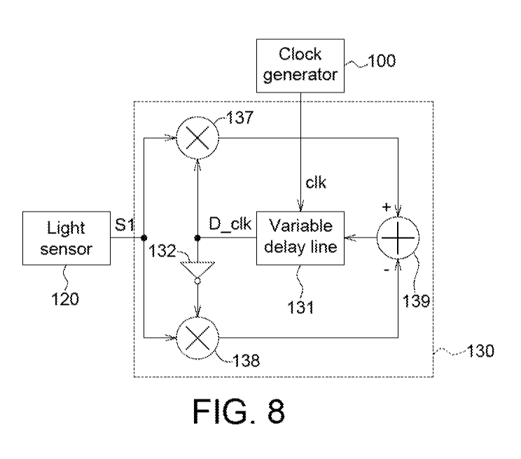

FIG. 8 shows a diagram illustrating a ranging control circuit according to an embodiment of this disclosure. In this embodiment, the ranging control circuit 130 includes a variable delay line 131, an inverter 132, a first multiplier-accumulator 137, a second multiplier-accumulator 138, and an adder 139. The inverter 132 receives the delayed clock signal D_clk to generate an inverted delayed clock signal. The first multiplier-accumulator 137 receives the delayed clock signal D_clk and the light sensing signal S1 to output a first accumulated product signal. The second multiplier-accumulator 138 receives the inverted delayed clock signal and the light sensing signal S1 to output a second accumulated product signal. The adder 139 subtracts the second accumulated product signal from the first accumulated signal (or subtracts the first accumulated product signal from the second accumulated signal) to generate a difference signal. The variable delay line 131 is controlled by the difference signal to generate the delayed clock signal D_clk.

The first multiplier-accumulator 137 may be implemented by a logic AND gate and an accumulator. The accumulator accumulates multiple results output from the logic AND gate. The corresponding waveform may be referred to FIG. 6 and FIG. 7. The first accumulated product signal may be regarded as the number of pulses that the light sensing signal S1 has during the enabled period of the delayed clock signal D_clk. The second accumulated product signal may be regarded as the number of pulses that the light sensing signal S1 has during the disabled period of the delayed clock signal D_clk. The delay amount of the variable delay line 131 changes when there is a difference between the first accumulated product signal and the second accumulated product signal, and then the difference between the first accumulated product signal and the second accumulated product signal will gradually decrease because of the changed delay amount. The steady state is reached when the output of the adder 139 is zero.

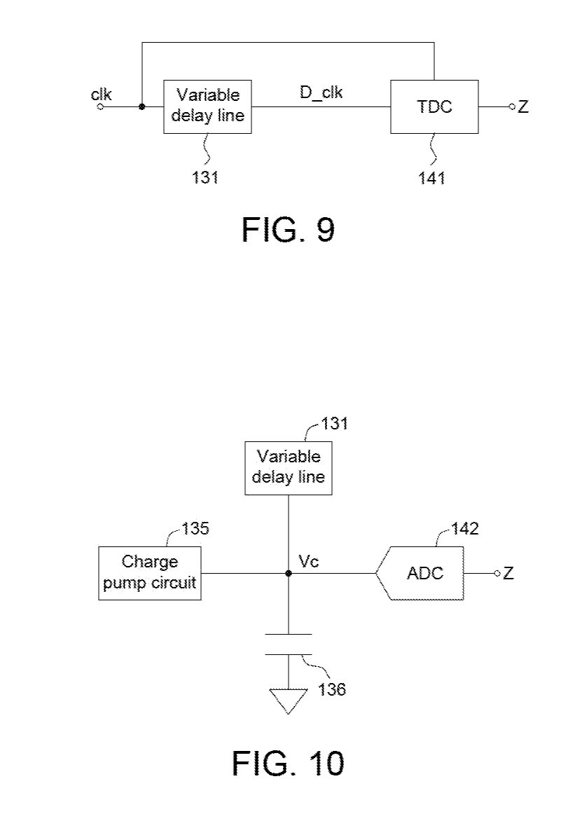

Several embodiments are given below for obtaining the delay amount of the variable delay line 131 shown in FIG. 5 or FIG. 8. In one embodiment, the ranging control circuit 130 further includes a time-to-digital converter (TDC) 141. FIG. 9 shows a diagram illustrating a time-to-digital converter for generating the ranging signal according to an embodiment of this disclosure. The TDC 141 receives the reference clock signal clk and the delayed clock signal D_clk to obtain the delay amount between the reference clock signal clk and the delayed clock signal D_clk, and generates the ranging signal Z accordingly.

In another embodiment, the ranging control circuit 130 further includes an analog-to-digital converter (ADC) 142. FIG. 10 shows a diagram illustrating analog-to-digital converter for generating the ranging signal according to an embodiment of this disclosure. Please also refer to FIG. 5, the delay amount of the variable delay line 131 is controlled by the voltage V_{C} of the capacitor 136. Therefore the ADC 142 may convert the voltage V_{C} of the capacitor 136 to the ranging signal Z.

According to the ranging device and ranging method in the embodiments given above, by tracking the energy characteristic point, the position where the light signal has a more severe non-ideal effect can be avoided, and a more accurate distance sensing result can be obtained. Further, because the tracking of the energy characteristic point is controlled by the relative relation between the first energy and the second energy, the ranging device and method in this disclosure is highly resistant to the ambient light interference. In addition, even if the duty cycle of the delayed clock signal is non-ideal or there is hardware mismatch in the charge pump circuit, the energy characteristic point can still be tracked successfully. Therefore there is no need for an additional calibration or compensation process for the ranging device and method in this disclosure. The ranging device in this disclosure adopts simple circuit architecture, and thus requires small circuit area and reduces the manufacture cost. The ranging device can be integrated into a single pixel structure, which can be applied to a pixel array. For example, the ranging device can be applied to a 3D Camera and a wide range of applications. In addition, the ranging device in this disclosure is compatible with the CMOS process and is easy for mass-production.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A ranging device, comprising:
a clock generator, configured to output a reference clock signal;
a light emitter, configured to generate an emitted light signal modulated by the reference clock signal and emit the emitted light signal to an object;
a light sensor, comprising a single photon avalanche diode, the light sensor configured to receive a reflected light signal reflected from the object to generate a light sensing signal; and
a ranging control circuit, comprising a variable delay line, the ranging control circuit configured to receive the reference clock signal and the light sensing signal, and generate a ranging signal accordingly to track an energy characteristic point of the light sensing signal.

2. The ranging device according to claim 1, wherein the variable delay line delays the reference clock signal to generate a delayed clock signal, the delayed clock signal tracks the energy characteristic point of the light sensing signal, such that a ratio of a first energy to a second energy is a fixed ratio, wherein the first energy is the energy that the light sensing signal has during an enabled period of the delayed clock signal, and the second energy is the energy that the light sensing signal has during a disabled period of the delayed clock signal.

3. The ranging device according to claim 2, wherein the delayed clock signal has successfully tracked the energy characteristic point of the light sensing signal when the first energy is approximately equal to the second energy.

4. The ranging device according to claim 2, wherein the first energy is related to the number of pulses that the light sensing signal has during the enabled period of the delayed clock signal, and the second energy is related to the number of pulses that the light sensing signal has during the disabled period of the delayed clock signal.

5. The ranging device according to claim 2, wherein the first energy is related to the time length that the light sensing signal overlaps with the enabled period of the delayed clock signal, and the second energy is related to the time length that the light sensing signal overlaps with the disabled period of the delayed clock signal.

6. The ranging device according to claim 1, wherein the ranging control circuit further comprises a charge pump circuit and a capacitor, the energy charged by the charge pump circuit to the capacitor is approximately equal to the energy discharged by the charge pump circuit for the capacitor when the delayed clock signal has successfully tracked the energy characteristic point of the light sensing signal.

7. The ranging device according to claim 1, wherein the ranging control circuit further comprises:
an inverter, for receiving the delayed clock signal to generate an inverted delayed clock signal;
a first D flip-flop, having a D input terminal for receiving the delayed clock signal, a clock input terminal for receiving the light sensing signal, and a Q output terminal for outputting a first charge/discharge control signal;
a second D flip-flop, having a D input terminal for receiving the inverted delayed clock signal, a clock input terminal for receiving the light sensing signal, and a Q output terminal for outputting a second charge/discharge control signal;
a capacitor, wherein the variable delay line generates the delayed clock signal according to the voltage of the capacitor; and
a charge pump circuit, for receiving the first charge/discharge control signal and the second charge/discharge control signal to charge and discharge the capacitor.

8. The ranging device according to claim 7, wherein the ranging control circuit further comprises:
an analog-to-digital converter, for converting the voltage of the capacitor to the ranging signal.

9. The ranging device according to claim 7, wherein the ranging control circuit further comprises:
a time-to-digital converter, for receiving the reference clock signal and the delayed clock signal to generate the ranging signal.

10. The ranging device according to claim 1, wherein the ranging control circuit further comprises:
an inverter, for receiving the delayed clock signal to generate an inverted delayed clock signal;
a first multiplier-accumulator, for receiving the delayed clock signal and the light sensing signal to output a first accumulated product signal;
a second multiplier-accumulator, for receiving the inverted delayed clock signal and the light sensing signal to output a second accumulated product signal; and
an adder, for subtracting the second accumulated product signal from the first accumulated signal to generate a difference signal;
wherein the variable delay line is controlled by the difference signal to generate the delayed clock signal.

11. A ranging method, comprising:
providing a reference clock signal;
generating an emitted light signal modulated by the reference clock signal and emitting the emitted light signal to an object;
receiving, by a light sensor, a reflected light signal reflected from the object to generate a light sensing signal, the light sensor comprising a single photon avalanche diode; and
receiving, by a ranging control circuit, the reference clock signal and the light sensing signal, and generating a ranging signal accordingly to track an energy characteristic point of the light sensing signal, wherein the ranging control circuit comprises a variable delay line.

12. The ranging method according to claim 11, wherein the variable delay line delays the reference clock signal to generate a delayed clock signal, the delayed clock signal tracks the energy characteristic point of the light sensing signal, such that a ratio of a first energy to a second energy is a fixed ratio, wherein the first energy is the energy that the light sensing signal has during an enabled period of the delayed clock signal, and the second energy is the energy that the light sensing signal has during a disabled period of the delayed clock signal.

13. The ranging method according to claim 12, wherein the delayed clock signal has successfully tracked the energy characteristic point of the light sensing signal when the first energy is approximately equal to the second energy.

14. The ranging method according to claim 12, wherein the first energy is related to the number of pulses that the light sensing signal has during the enabled period of the delayed clock signal, and the second energy is related to the number of pulses that the light sensing signal has during the disabled period of the delayed clock signal.

15. The ranging method according to claim 12, wherein the first energy is related to the time length that the light sensing signal overlaps with the enabled period of the delayed clock signal, and the second energy is related to the time length that the light sensing signal overlaps with the disabled period of the delayed clock signal.

16. The ranging method according to claim 11, wherein the ranging control circuit further comprises a charge pump circuit and a capacitor, the energy charged by the charge pump circuit to the capacitor is approximately equal to the energy discharged by the charge pump circuit for the capacitor when the delayed clock signal has successfully tracked the energy characteristic point of the light sensing signal.

17. The ranging method according to claim 11, wherein the step of generating the ranging signal by the ranging control circuit comprises:
providing an inverter, for receiving the delayed clock signal to generate an inverted delayed clock signal;
providing a first D flip-flop, having a D input terminal for receiving the delayed clock signal, a clock input terminal for receiving the light sensing signal, and a Q output terminal for outputting a first charge/discharge control signal;
providing a second D flip-flop, having a D input terminal for receiving the inverted delayed clock signal, a clock input terminal for receiving the light sensing signal, and a Q output terminal for outputting a second charge/discharge control signal;
providing a capacitor, wherein the variable delay line generates the delayed clock signal according to the voltage of the capacitor; and
providing a charge pump circuit, for receiving the first charge/discharge control signal and the second charge/discharge control signal to charge and discharge the capacitor.

18. The ranging method according to claim 17, wherein the step of generating the ranging signal by the ranging control circuit further comprises:
converting the voltage of the capacitor to the ranging signal by an analog-to-digital converter.

19. The ranging method according to claim 17, wherein the step of generating the ranging signal by the ranging control circuit further comprises:
receiving the reference clock signal and the delayed clock signal to generate the ranging signal by a time-to-digital converter.

20. The ranging method according to claim 11, wherein the step of generating the ranging signal by the ranging control circuit comprises:
providing an inverter, for receiving the delayed clock signal to generate an inverted delayed clock signal;
providing a first multiplier-accumulator, for receiving the delayed clock signal and the light sensing signal to output a first accumulated product signal;
providing a second multiplier-accumulator, for receiving the inverted delayed clock signal and the light sensing signal to output a second accumulated product signal; and
providing an adder, for subtracting the second accumulated product signal from the first accumulated signal to generate a difference signal;
wherein the variable delay line is controlled by the difference signal to generate the delayed clock signal.
